(19) United States
(12) Patent Application Publication
(10) Pub. No.: US 2022/0323954 A1
(43) Pub. Date: Oct. 13, 2022

(54) TRANSFER SYSTEM FOR SAMPLES, MORE PARTICULARLY SAMPLES TO BE ANALYZED

(71) Applicant: THINXXS MICROTECHNOLOGY AG, Zweibrücken (DE)

(72) Inventors: Lutz WEBER, Münchweiler (DE); Tina RÖSER, Brohl (DE)

(21) Appl. No.: 17/616,004

(22) PCT Filed: May 5, 2020
(86) PCT No.: PCT/EP2020/062394

§ 371 Date: Dec. 2, 2021

(30) Foreign Application Priority Data
Jun. 7, 2019 (EP) 19179090.6

(51) Int. Cl. B01L 3/00

(52) U.S. Cl. CPC B01L 3/502715; B01L 2200/0605; B01L 2200/0689; B01L 2200/16; B01L 2300/042; B01L 2400/0406; B01L 2300/0681

(57) ABSTRACT

A system for transferring a sample from a sample recovery or provision device to a microfluidic processing device, more particularly an analysis device, preferably in the form of a flow cell, with a sample carrier that removes the sample from the sample recovery or provision device and can be transported to the processing device. The sample carrier can be connected to the sample recovery or provision device and can be detached from sample recovery or provision device, with the sample being automatically removed. The sample carrier connected to the sample recovery or provision device is preferably a functional component of the sample recovery or provision device, more particularly the sample carrier closes a container space of the sample recovery or provision device for receiving sample material.

The invention relates to a system for transferring a sample from a sample recovery or preparation device to a microfluidic processing device, in particular an analysis device, with a sample carrier that removes the sample from the sample recovery or preparation device and is transportable to the processing device.

Such a system for sample transfer is known for example from EP 3 108 962 A1, included here. The sample carriers of this known system are connectable to the sample processing device for the purpose of introducing a sample into the sample processing device forming a flow cell, wherein the sample carrier connected to the processing device then forms an integral part of the flow cell, which part closes a sample-receiving space inside the flow cell in a fluid-tight manner.

The transfer of the sample from the sample recovery or preparation device to the sample carrier requires a certain amount of effort.

The object of the invention is to create a novel transfer system of the type mentioned in the introduction, in which the transfer of the samples from the sample recovery or preparation device to the sample carrier is made easier.

The system according to the invention, which achieves this object, is characterized in that the sample carrier is connectable to the sample recovery or preparation device, and, with automatic removal of the sample, is detachable from the sample recovery or preparation device.

Advantageously, according to the invention, the removal of the sample by the sample carrier takes place automatically when the sample carrier is detached from the sample recovery or preparation device.

In a particularly preferred embodiment of the invention, a precisely measured amount of sample is removed automatically.

The sample is preferably a liquid sample, in which case a sample receiving region of the sample carrier connected to the sample recovery or preparation device is wettable with sample liquid.

In a further preferred embodiment of the invention, the sample carrier connected to the sample recovery or preparation device forms a functional component of the sample recovery or preparation device.

As a functional component, the sample carrier connected to the sample recovery or preparation device closes off in particular a sample-material-receiving container space of the sample recovery or preparation device during the sample recovery or preparation.

In a further preferred embodiment of the invention, a sample receiving region of the sample carrier connected to the sample recovery or preparation device adjoins a sample-material-receiving container space enclosed by the sample recovery or preparation device. Sample material collected in the container space can thus come into contact with the sample carrier and adhere to the sample receiving region of the sample carrier.

The sample is preferably held, at least partially exposed, on the sample receiving region of the sample carrier by adhesion forces, in particular by capillary forces, wherein the holding forces meet the requirements applying to the transport of the sample carrier.

It will be appreciated that the sample carrier can moreover be connectable to the sample processing device, with automatic introduction of the sample into the sample processing device.

In particular, the sample carrier for connection to the sample recovery or preparation device and/or to the sample processing device can be inserted with a plug portion, in particular a conical plug portion, into an opening of the sample recovery or preparation device or of the sample processing device, preferably in a fluid-tight manner.

The sample receiving region is expediently arranged on an end face of this plug portion and preferably extends as a depression from this end face into the plug portion. Such a design of the sample receiving region advantageously results in sufficiently high capillary forces, it being possible for these forces to be increased by making the receiving region hydrophilic. By contrast, surfaces adjoining the receiving region can be made hydrophobic, in order to sharply delimit the sample receiving region and thus precisely measure an amount of sample.

Substances can advantageously adhere to at least part of the surface of the sample receiving region, e.g. a dried reagent that interacts with the sample, in particular an anticoagulant in the case where blood is the sample material.

A grip portion for handling, in particular for manual handling, of the sample carrier expediently extends from the other end face of the plug portion.

It will be appreciated that the opening that receives the plug portion leads into a container space of the sample recovery or preparation device or of the sample processing device.

In one embodiment, the sample recovery or preparation device is a blood sampling device.

However, the sample recovery or preparation device can also essentially comprise for example just a receptacle, e.g. for receiving urine.

In a further embodiment, the sample recovery or preparation device and the sample processing device are formed by a single flow cell, wherein e.g. pre-processed sample material is removed from one location of the flow cell and is fed through the sample carrier e.g. to another region of the flow cell as a sample that is to be processed.

The sample recovery or preparation device can comprise a filter element that retains blood constituents, e.g. solid blood constituents, in order to recover a blood plasma sample.

The sample receiving region of the sample carrier can have a porous membrane which sucks in the sample. The sample sucked in can then be fully or partially released again for example by being washed or flushed out with a washing or flushing liquid in the processing device. Alternatively, the sample remains in the membrane and dries there and, after intermediate storage or transport, is if necessary redissolved and analyzed. It can be advantageous here to functionalize the membrane by applying reagents before the sample is sucked in, so as to prevent or minimize damage to the sample by the drying process.

Moreover, the membrane can also be functionalized in such a way that reagents used for this purpose, which may be applied locally dissolved, react directly with the sample and, e.g. by a color change, identify one or more constituents of the sample and make them visible. In this case, the sample carrier itself assumes a processing function.

In addition to a sample processing device in the form of a flow cell, in which the receiving region of the sample carrier with the sample is brought into connection with a channel and the sample is flushed out with a washing liquid for example, a sample processing device can also be designed simply as an open reagent vessel or as a membrane.

In the former case, the sample can be brought into contact with a washing liquid located in the reaction vessel and, by movement of the sample carrier immersed in the washing liquid with the sample receiving region, can be washed out in order then to be further processed in a manner mixed with the washing liquid.

In the latter case, the sample is further processed or stored with the aid of a sample processing device that is formed by the membrane itself, which takes up the sample from the sample receiving region of the sample carrier by capillary action.

The invention is explained in more detail below on the basis of exemplary embodiments and with reference to the accompanying drawings relating to these exemplary embodiments, in which:

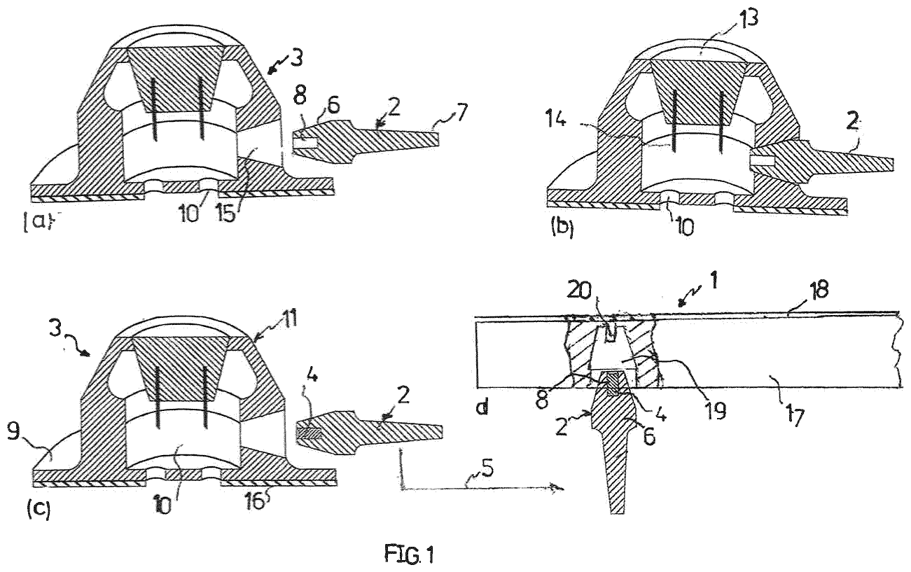

FIG. 1 shows a first exemplary embodiment of a transfer system according to the invention, with a blood sampling device as a sample recovery or preparation device,

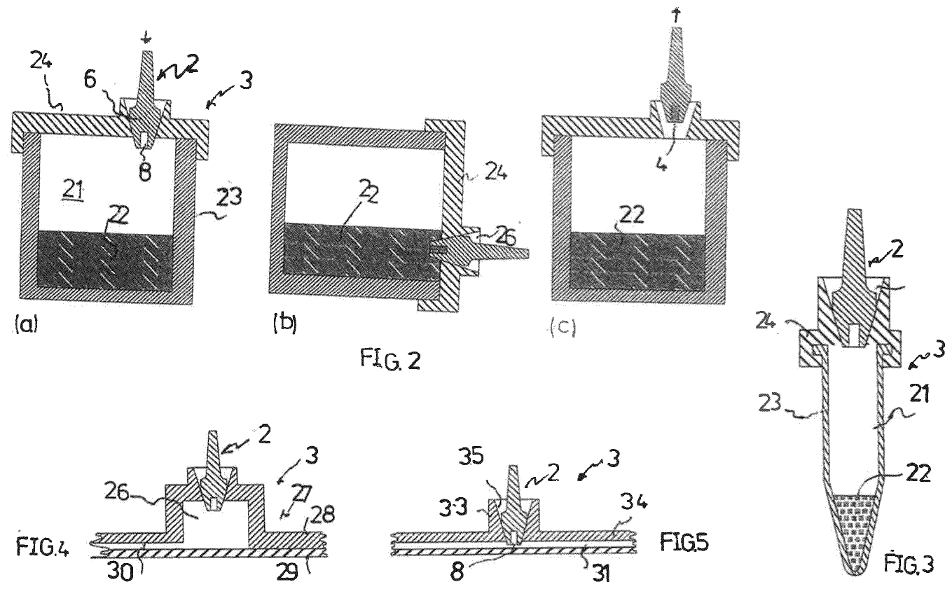

FIGS. 2 and 3 show exemplary embodiments, essentially formed by containers, of sample recovery or preparation devices of the transfer system according to the invention,

FIGS. 4 and 5 show sample recovery or preparation devices according to the invention that are formed by a flow cell,

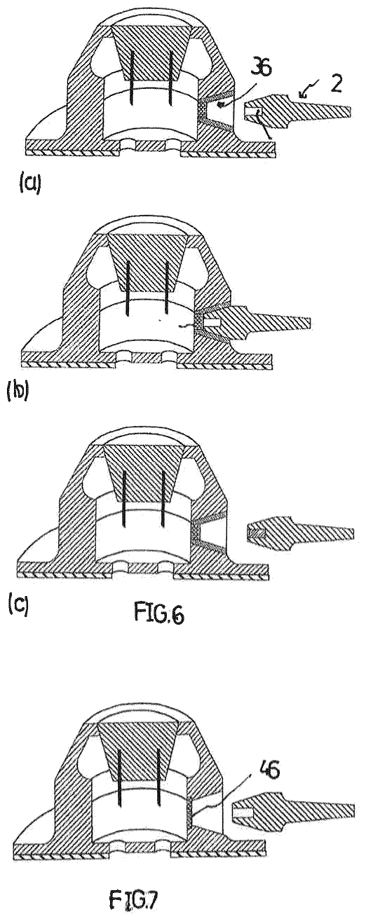

FIGS. 6 to 8 show sample recovery or preparation devices according to the invention for recovering a blood plasma sample,

FIGS. 9 to 11 show exemplary embodiments of sample carriers according to the invention, and

FIGS. 12 to 14 show embodiments of sample processing devices.

An arrangement of devices shown in FIG. 1 comprises a microfluidic sample processing device 1 in the form of a flow cell, a sample carrier 2, and a sample recovery or preparation device 3, in the example shown a device for taking blood from the human body. With the aid of the sample carrier 2, it is possible, according to arrow 5, to transfer a liquid sample 4 from the sample recovery or preparation device 3 to the sample processing device 1 and to introduce the sample into the latter. The sample carrier 2 is preferably produced in one piece, e.g. from PMMA, PC, COC, COP, PP or PE, by injection molding.

In the example shown, the sample carrier 2 has a plug portion 6 which is partially conical (with, for example, a 6% taper according to the LUER standard) and from one end face of which there extends a grip portion 7 for handling the sample carrier, and at the other end face of which there is a receiving region 8 for the liquid sample 4. The receiving region is formed by a groove in which the liquid sample 4 is held by capillary forces.

The sample recovery and preparation device or blood sampling device 3 has a base plate 9, which can be placed on the upper arm, for example, for taking blood, and which has an adhesive layer 16 and through-openings 10. An attachment 11 extends from the base plate 9 and, together with the base plate 9, forms a sample collection and storage space 12 into which the through-openings 10 lead. A flexible end portion of the attachment 11 comprises a push button 13 with embedded needle pins 14 which, when the push button 13 is actuated, penetrate through the openings 10 into the skin of the person giving blood. Blood sampling devices of this type (without the sample carrier 2) are known from US 20170172481 A1 and US 20130211289 A1, for example.

Moreover, a conical through-opening 15 for receiving the plug portion 6 of a sample carrier 2 leads into the collection and storage space 12.

The sample processing device or flow cell 1, which in the example shown is plate-shaped and formed by a substrate 17 and by a film 18 covering channels and chambers in the substrate, has a partially conical opening 19 for receiving the plug portion 6 of a sample carrier 2. As can be seen from FIG. 1d, a channel 20, which is part of the channel and chamber system of the flow cell 1 and forms both an inflow and an outflow to the opening 19, leads into the opening 19. The groove-shaped receiving region 8 can be aligned with the channel, with the cross section of which it is partially congruent.

During a blood sampling procedure, after actuation of the push button 13, blood enters the collection and storage space 12 through the openings 10. The sample carrier 2 meanwhile closes the opening 15 in a fluid-tight manner, the blood sampling device 3 being oriented in such a way that the sample carrier 2 extends vertically upward with the receiving region 8. Collected blood thus reaches the groove-shaped receiving region 8, which then fills with the liquid sample 4 under the action of capillary forces.

It will be appreciated that the plug portion 6 can be held securely in the through-opening 15 by a clamping force, but at the same time the clamping force is so low that the sample carrier 2 can be easily detached from the blood sampling device 3.

When the sample carrier 2 is detached from the blood sampling device 3, only the amount of liquid measured by the groove 4 remains on the sample carrier 2. By surface treatment of the groove region and of the adjoining regions (hydrophilization, hydrophobization), it can be ensured that a sharp division is established between the wettable regions and the adjoining regions, such that, outside of the receiving region 8, little or no sample liquid remains on the sample carrier.

The amount of sample precisely measured in this way can now be transferred to the flow cell 1 by inserting the sample carrier 2, transported to the location of the flow cell, into the opening 19 of the flow cell and aligning the groove-shaped receiving region 8 with the channel 20, if appropriate by rotation of the sample carrier.

The liquid sample 4 can then be transported further inside the flow cell 1, by flushing, and processed, in particular analyzed.

Whereas in the exemplary embodiment of FIG. 1 a sample container space, i.e. the collection and storage space 12, is enclosed by the blood sampling device 3, FIG. 2 shows a sample recovery or preparation device 3 which basically just amounts to a container space 21 that is used, for example, to receive urine as a sample material 22. The sample recovery or preparation device comprises a vessel part 23, and a lid 24 that closes the vessel part 23 in a fluid-tight manner. The lid 24 has a conical through-opening 25 into which a sample carrier 2 with a partially conical plug portion 6 can be inserted in a fluid-tight manner.

To remove a defined amount of sample, the sample container space 21 is rotated, in accordance with FIG. 2b, for example through approximately 90°, such that a groove-shaped sample receiving region 8 of the sample carrier 2 is wetted with liquid sample material.

As can be seen from FIG. 2c, after renewed rotation of the sample container space 21, a liquid sample 4 with a desired amount of sample remains in the sample receiving region 8. As has been described with reference to FIG. 1, the liquid sample 4 can now be transferred to a sample processing device and introduced into the latter.

An elongate storage container space 21, shown in FIG. 3, for receiving sample material 22 is formed by a vessel part 23 and a lid part 24. A conical through-opening 25 for receiving a sample carrier 2 corresponding to the sample carrier of FIGS. 1 and 2 is formed in the lid part. To remove a metered amount of sample, the sample container space 21 is temporarily rotated through 180°. The vessel part 23 can be used, for example, as a collecting container for a blood recovery device or as a reaction vessel for one or more process steps of a sample analysis.

FIG. 4 shows a sample container space 26 which is part of a flow cell 27 with a substrate 28 and a cover film 29. The sample container space 26 is in communication with at least one channel 30, which forms part of the channel and chamber system of the flow cell 27.

The sample container space 26 can, for example, contain sample material pre-processed by the flow cell 27, of which a sample can be transferred through a sample carrier 2, which can be coupled to the sample container space 26, into another region of the flow cell 27 that has an opening according to FIG. 1d.

In an exemplary embodiment shown in FIG. 5, a sample container space is formed simply by a channel 31 within a flow cell 32. An attachment 33 on a substrate 34 of the flow cell 32 has a conical through-opening 35 for receiving a sample carrier 2, the sample receiving region 8 of which can come into contact with liquid flowing through the channel 31. Also in the exemplary embodiment of FIG. 5, a sample could be transferred into another region of the flow cell 32 (or into another flow cell).

FIG. 6 shows an exemplary embodiment with a blood sampling device according to FIG. 1, but in which a cap-shaped sleeve part 36 with an outer cone and inner cone is inserted into the conical through-opening. The sleeve part 36, which can be firmly connected to the blood sampling device, has at one end a filter element 37 in the form of a porous glass or synthetic fiber membrane, which is expediently welded to the rest of the sleeve part. The filter element 37 coming into contact with collected blood retains solid blood constituents, such that the receiving region 8 of a carrier element 2 fills only with blood plasma by capillary force, said blood plasma being able to be fed to a flow cell as a sample that is to be analyzed.

In a simplified embodiment according to FIG. 7, a filter membrane 46 retaining solid blood constituents is simply connected, in particular welded, to the blood sampling device.

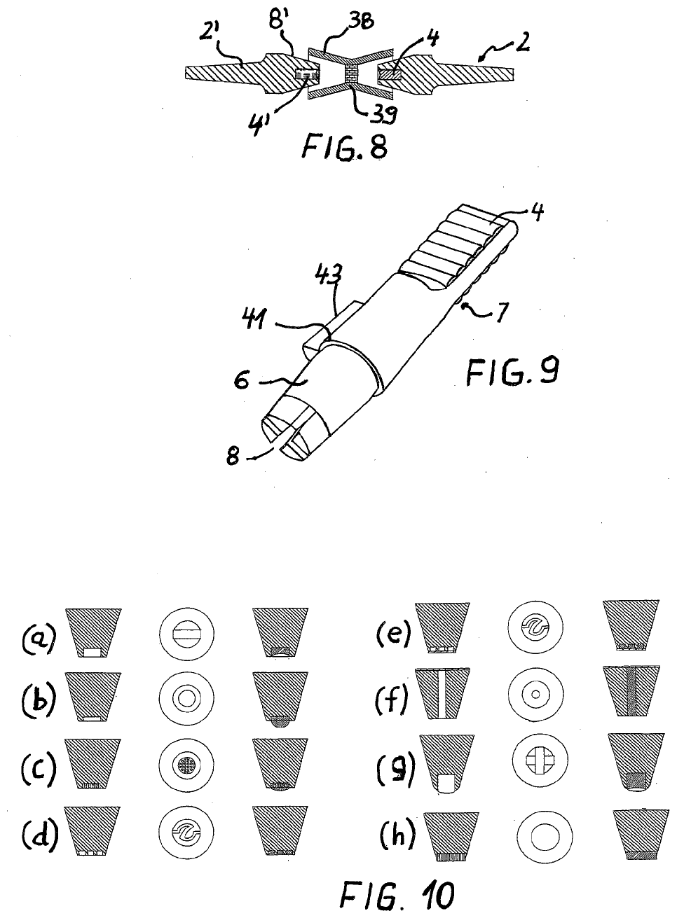

In an exemplary embodiment according to FIG. 8, a sample carrier 2′ with a partially conical plug portion 8′ forms, together with a connection piece 38, which has an inner cone on mutually opposite sides, and with a filter element 39, a device for recovering a fluid sample that is to be fed to a sample carrier 2. In the example shown, the carrier 2′ contains an amount of blood 4 that can be fed in a filtered state to the carrier element 2, the filter element 39 retaining solid constituents of the blood, such that the sample carrier 2 receives a blood plasma sample 4 in its sample receiving region.

The sample carrier 2 used identically in the exemplary embodiments of FIGS. 1 to 8, with a sample receiving region 8 formed by a single groove, could also be designed as in FIG. 9 for example and have, for example, a sample receiving region 8 formed by two intersecting grooves.

A grip region 7 of the sample carrier of FIG. 9 adjoins a conical plug portion 6 via a step 41 and is provided with a profile 42 that promotes gripping.

Extending radially from the grip region 7 is a nose portion 49, which on the one hand forms a lever that facilitates rotation of the sample carrier in a coupled state and additionally permits determination of the rotational position of the sample carrier and thus an alignment of its receiving region 8 with a channel of a processing device.

Deviating from the example shown in FIGS. 1 to 9, the grip region could also be designed as a rotary knob.

FIG. 10 shows a large number of possibilities as regards the geometric configuration of the sample receiving region of a sample carrier.

It will be appreciated that in FIG. 10 only the conical sealing region of a sample carrier, without grip attachments or the like, is shown in each case.

In the exemplary embodiments of FIGS. 10a to 10d, the sample receiving region is formed by differently shaped depressions in a flat end face of the sample carrier, in such a way that capillary forces act to hold the sample on the receiving region. The sample can be easily flushed out of the sample receiving regions which are open at one side and are optionally hydrophilized.

In the exemplary embodiment of FIG. 10e, channel-shaped depressions, like those of the sample carriers of FIG. 10d, are covered by a plastic film. The surfaces of the covered channels of the two-piece sample carrier can be completely or partially hydrophilized. By capillary filling of the channels, a sample can be measured off very precisely, wherein the capillary filling concludes automatically at the channel end, without the risk of overfilling.

FIG. 10f shows a further two-part embodiment with a through-hole forming the sample receiving region, and with a membrane closing the through-hole at one end. Air can escape through the membrane as the sample receiving region is being filled, whereas the membrane is impermeable to the sample. The narrow, capillary-fillable through-hole, the diameter of which is between 0.1 and 2 mm, preferably between 0.2 and 0.5 mm, also permits very precise measurements of a sample. The sample receiving region can be removed from the through-hole within a flow cell by application of pneumatic or hydraulic pressure.

The exemplary embodiment of FIG. 10g differs from the preceding exemplary embodiments in having a rounded end face, into which a cross-slot-shaped receiving region is sunk. This rounding results in greater measuring precision, since less sample material remains caught on it.

FIG. 10f shows a further two-part exemplary embodiment in which the sample receiving region is formed by a filter element attached to an end face of the sample carrier. Upon contact, the filter element sucks in the sample, its volume and porosity being decisive in terms of the amount of sample taken up.

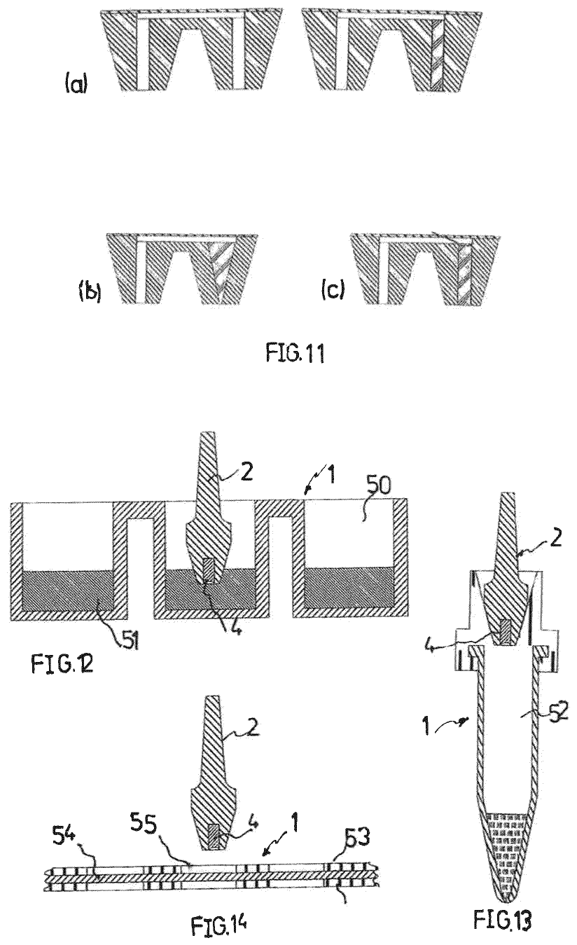

FIG. 11 shows exemplary embodiments of two-part sample carriers with two conical receiving regions for connection to a flow cell and to a sample recovery or preparation device.

According to FIG. 11a, a through-hole in one of the connection regions a capillary-fillable sample receiving region, which at one end adjoins a flushing channel covered by a film and whose capillary filling with a sample ends automatically at the flushing channel. The flushing channel is in communication with a through-hole in the other connection region. By way of the connection regions that are simultaneously connected to one flow cell, the receiving region can be emptied by application of pneumatic or hydraulic pressure.

The exemplary embodiment of FIG. 11 b differs from the exemplary embodiment of FIG. 11a in terms of a sample receiving region that tapers toward the inlet opening. The taper increases the reproducibility of the amount of sample taken up. The diameter of the sample receiving region is less than 0.1 to 0.3 mm at the inlet and 0.5 to 2 mm at the outlet, the length of the through-hole typically measuring 2 to 10 mm. It will be appreciated that the take-up capacity of the sample carrier depends on the dimensions of the sample region, and different amounts of sample can be introduced into a flow cell simply by exchanging the sample carrier. From the different geometry of the through-holes in the receiving regions, it can be seen which of the two through-holes serves as receiving region.

In the exemplary embodiment of FIG. 11c, the end facing toward the flushing channel is narrowed in its cross section of flow. This narrowing acts as a stop for the capillary filling of the sample receiving region, which is conducive to reproducible measuring of samples. Typical narrowing of the cross section of flow is between 10 and 50%, the length of the narrowed region in the direction of flow being between 0.05 and 0.2 mm.

A sample carrier 2 shown in FIG. 12 transports a sample 4 from a sample recovery or preparation device (not shown) to a sample processing device 1. In the example shown, the sample processing device 1 is simply a microtiter plate, shown in part in FIG. 12, with e.g. 96 reaction vessels 50 that each contain washing liquid 51.

As a result of a vibrating movement, for example, of the sample carrier 2 immersed in the washing liquid 51, the sample 4 is flushed out of the sample receiving region of the sample carrier. The mixture of sample and washing liquid remaining in the reaction vessel 50 can then be processed further.

FIG. 13 shows a further sample processing device 1 in the form of a single reaction vessel 52, which can be connected to a sample carrier 2 in a fluid-tight manner. A sample 4 transported by the sample carrier 2 can be washed out of the receiving region of the sample carrier 2, for example by manual shaking of the reaction vessel 52 containing washing liquid 51, and the mixture of sample and washing liquid can be further processed after removal from the reaction vessel.

FIG. 14 shows a sample carrier 2 with a sample 4 which is transported by the sample carrier 2 and which is fed to a processing device 1.

The processing device 1 comprises two carrier material layers 53, 53′, between which an absorbent porous membrane 54 is introduced. At least one of the carrier material layers 53, 53′ is perforated in sample input regions 55. When the sample carrier 2 is pressed onto the membrane 54, the sample 4 comes into contact with the membrane 54 and is sucked in through the membrane 54. The suction capacity of the membrane exceeds the capillary force in the sample receiving region of the sample carrier, such that the sample passes into the membrane 54, and does so completely, since the take-up capacity of the exposed membrane region is greater than the sample volume.

The membrane 54 can be provided with dried reagents which interact with the sample. It is also possible that the sample is dried out in the membrane.

Common to all the sample carriers is a more or less open amount of liquid sample that is kept accessible for flushing out.

It will be appreciated that, deviating from the connection cone exclusively described above, other connecting means can also be considered for the sample carrier.

1-15. (canceled)

16. A system for transferring a sample, comprising: a sample recovery or preparation device; a microfluidic processing device; and, a sample carrier configured to remove the sample from the sample recovery or preparation device and be transportable to the microfluidic processing device for transferring the sample from the sample recovery or preparation device to the microfluidic processing device, wherein the sample carrier is configured to be connectable to the sample recovery or preparation device and, with automatic removal of the sample, detachable from the sample recovery or preparation device.

17. The system according to claim 16, wherein the microfluidic processing device is a flow cell.

18. The system according to claim 16, wherein the sample is a liquid sample, and the sample carrier has a sample receiving region connected to the sample recovery or preparation device, the sample receiving region being wettable with sample liquid.

19. The system according to claim 18, wherein the sample carrier is configured to form a functional component of the sample recovery or preparation device when connected to the sample recovery or preparation device.

20. The system according to claim 19, wherein the sample carrier is configured to close off a sample-material-receiving container space of the sample recovery or preparation device when connected to the sample recovery or preparation device as a functional component of the sample recovery or preparation device.

21. The system according to claim 20, wherein the sample receiving region of the sample carrier when connected to the sample recovery or preparation device adjoins the sample-material-receiving container space of the sample recovery or preparation device.

22. The system according to claim 16, wherein the sample carrier is configured to be detachable from the sample recovery or preparation device with automatic removal of a metered amount of sample.

23. The system according to claim 22, wherein the sample carrier is configured to have a metering accuracy of <10%.

24. The system according to claim 16, wherein the sample carrier is configured to be connectable to the sample processing device so as to introduce the sample into the sample processing device.

25. The system according to claim 24, wherein the sample carrier has a plug portion for connection to the sample recovery or preparation device or/and to the sample processing device, the plug portion being insertable into an opening of the sample recovery or preparation device or of the sample processing device.

26. The system according to claim 25, wherein the plug portion is conical.

27. The system according to claim 25, wherein the sample receiving region is arranged on one end face of the plug portion and an other end face of the plug portion forms a grip region for handling the sample carrier.

28. The system according to claim 27, wherein the sample receiving region extends from the end face into the plug portion.

29. The system according to claim 16, wherein the sample is held, at least partially exposed, on a sample receiving region of the sample carrier by adhesion forces.

30. The system according to claim 29, wherein the sample is held by capillary forces.

31. The system according to claim 16, wherein the sample is a blood sample.

32. The system according to claim 31, wherein the sample recovery or preparation device comprises a filter element that retains solid blood constituents in order to recover a blood plasma sample.

33. The system according to claim 16, wherein the sample carrier has a sample receiving region and the sample processing device has an input region, the sample receiving region or the input region having a porous membrane with a sample receiving capacity greater than a sample volume receivable by the sample carrier.

34. The system according to claim 16, wherein the sample carrier has a sample receiving region with a surface, at least a part of the surface of the sample receiving region having at least one reagent that interacts with the received sample.

35. The system according to claim 16, wherein the sample recovery or preparation device is configured so that several sample carriers are connectable to the sample recovery or preparation device simultaneously or in succession so that several samples are removable.
